(19) United States
(12) Patent Application Publication
(10) Pub. No.: US 2006/0108335 A1
(43) Pub. Date: May 25, 2006

(54) Laser penetration weld

(76) Inventors: Hailiang Zhao, Maple Grove, MN (US); Jeffrey S. Lund, Forest Lake, MN (US)

Correspondence Address: MEDTRONIC, INC., 710 MEDTRONIC PARK, MINNEAPOLIS, MN, 55432-9924, US

(21) Appl. No.: 11/260,911

(22) Filed: Oct. 28, 2005

Related U.S. Application Data
(60) Provisional application No. 60/623,326, filed on Oct. 29, 2004.

(51) Int. Cl. B23K 26/22; B23K 20/10; B23K 11/10

(52) U.S. Cl. 219/121.64; 219/86.1; 228/110.1

(57) ABSTRACT

Laser penetration of tabs from electrode plates is presented. A set of tabs associated with a set of electrode plates are aligned. Either resistance spot welding or ultrasonic welding is used to hold the set of tabs together. A laser penetration weld is created through the set of tabs by a single pulse laser weld or multiple-pulse laser weld. The set of tabs is greater than two tabs.

### INCORPORATION BY REFERENCE

This non-provisional U.S. patent application hereby claims the benefit of U.S. provisional patent application Ser. No. 60/623,326, filed Oct. 29, 2004, entitled “Flat Plate Electrochemical Cell for an Implantable Medical Device”, the contents of which are incorporated by reference herein.

### FIELD OF THE INVENTION

The present invention relates generally to an electrochemical cell and, more particularly, to welding of tabs extending from electrode plates.

### BACKGROUND

Implantable medical devices (IMDs) detect and treat a variety of medical conditions in patients. Exemplary IMDs include implantable pulse generators (IPGs) or implantable cardioverter-defibrillators (ICDs) that deliver electrical stimulation to tissue of a patient. IMDs typically include, inter alia, a control module, a capacitor, and a battery that are housed in a hermetically sealed container. When therapy is required by a patient, the control module signals the battery to charge the capacitor, which in turn discharges electrical stimuli to tissue of a patient.

An electrochemical cell (e.g. battery, capacitor) includes a case, an electrode stack, and a liner that mechanically immobilizes the electrode stack within the housing. The electrode stack is a repeated series of an anode plate, a cathode plate with a separator therebetween. Each anode plate and cathode plates include a tab. A set of tabs from a set of anode plates are held in place by a fixture tool and then the tabs are joined through resistance spot welding (RSW). A similar process is applied to tabs from the cathode plates. Securely fixing the tabs with a fixture tool and then performing RSW on a the set of tabs is time consuming. For example, RSW only allows two plates to be resistance welded at a time. Therefore, multiple welds are used to join all of the tabs from the anode plates. Additionally, since each weld is placed a certain distance away from another weld, the welding area increases as the number of anode and cathode plates increase to form, for example, a high current rate battery. An increased area for welding may detrimentally increase the size of a battery, which in turn may increase the size of an IMD. It is therefore desirable to develop a method that overcomes these limitations.

### BRIEF DESCRIPTION OF THE DRAWINGS

FIG. 1 is a top perspective view of an exemplary electrochemical cell;

FIG. 2 is a cross-sectional view of a weld zone for an exemplary laser penetration weld;

FIGS. 3A-3B are top and bottom views respectively of a weld pool zone in a set of tabs created during laser penetration weld;

FIG. 4 is a top perspective view of an exemplary laser penetration weld of a set of tabs associated with a set of electrode plates;

FIG. 5 depicts multiple laser penetration weld zones formed in a set of tabs;

FIGS. 5A and 5B depict top and bottom views of the weld zone depicted in FIG. 5;

FIG. 6A depicts a top perspective view of a single penetration weld through a set of tabs and a top portion of a housing;

FIG. 6B depicts a top perspective view of a single penetration weld through a set of tabs and a feed-through pin;

FIG. 7 is block diagram of a system that automatically creates laser penetration welds in a set of tabs associated with a set of electrode plates; and

FIG. 8 is a flow diagram for forming a laser penetration weld through a set of tabs associated with a set of electrode plates; and

FIG. 9 is another flow diagram for creating a laser penetration weld in a set of tabs.

### DETAILED DESCRIPTION

The following description of the embodiments is merely exemplary in nature and is in no way intended to limit the invention, its application, or uses.

For purposes of clarity, the same reference numbers are used in the drawings to identify similar elements. As used herein, the term “module” refers to an application specific integrated circuit (ASIC), an electronic circuit, a processor (shared, dedicated, or group) and memory that execute one or more software or firmware programs, a combinational logic circuit, or other suitable components that provide the described functionality.

The present invention is directed to fixturing of a set of tabs through either resistance spot welding or ultrasonic welding. The tabs then undergo laser penetration welding. Cost of producing an electrochemical cell is reduced since RSW or ultrasonic welding does not require the use of a fixture tool to hold the set of tabs in place during laser penetration welding. Moreover, this process provides higher weld quality and manufacturability than other forms of laser welding design such as welding from the sides of the tabs.

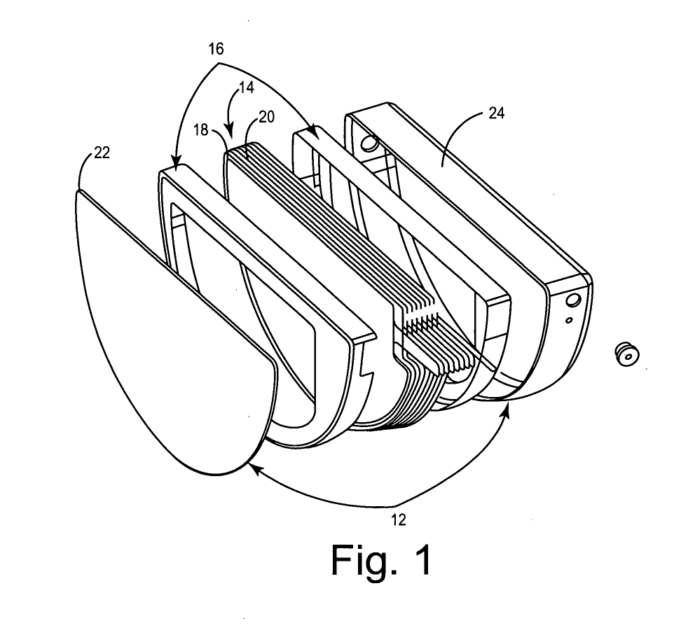

FIG. 1 depicts an exemplary electrochemical cell 10 (e.g. battery, capacitor etc.) for an implantable medical device (IMD). Electrochemical cell 10 includes a housing 12, an electrode stack 14, and a liner 16. Housing 12 is formed of a first portion 22 (or lid) welded to a second portion 24 (or bottom). Liner 16 surrounds electrode stack 14 to prevent direct contact between electrode stack 14 and housing 12. A detailed example of such a configuration may be seen with respect to U.S. Pat. No. 6,459,566B1 issued to Casby et al. and U.S. Patent Publication No. 2003/0199941A1, and assigned to the assignee of the present invention, the disclosure of which is incorporated by reference, in relevant parts.

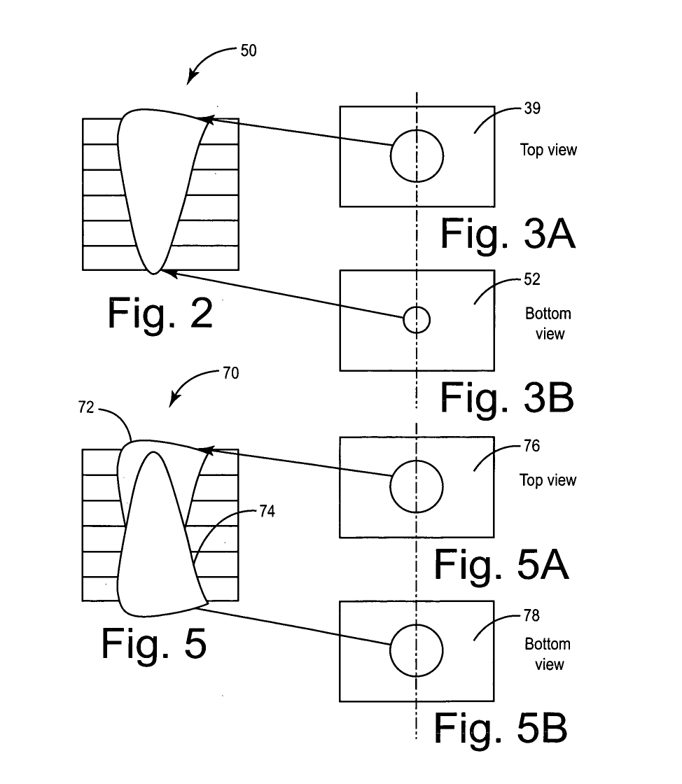

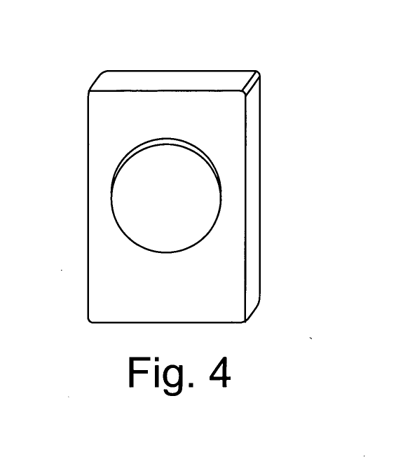

Referring to FIGS. 2-3B and 6A-6B, an electrode stack 14 is a repeated series of an anode plate 18, a cathode plate 20, with a separator 19 therebetween. Tabs 37 from anode plates 18 are aligned and then fayed or squeezed together to reduce any potential gaps that may exist between tabs 37. Face 39 of tabs 37 is orthogonal (or at a right angle) or slightly slanted to a laser beam (not shown). The laser beam device emits a single continuous laser beam for a period of up to tens of milliseconds or several such laser beam pulses with a brief interval in between. The laser beam contacts face 39 of tabs 37. A weld pool or zone 50 is created from face 39 to bottom 52 of tabs 37, as shown in FIG. 2. Weld zone 50 is formed via conduction mode welding or deep-penetration-mode (i.e. keyhole mode) welding. These two modes of welding are described in greater detail by Olsen, David LeRoy et al., American Society for Metals International (ASM) Handbook, Vol. 6: Welding, Brazing, and Soldering, page 264 (December 1993). Generally, the laser energy initiates melting from face 39 of the top plate of set of tabs 37 and progressively melts through the plates below until the plate on the bottom 52 of set of tabs 37 is melted therethrough. A melt mark is typically visible on the bottom 52 set of tabs 37, thereby creating a single laser penetration weld, depicted in FIG. 4, through more than two tabs from a set of tabs 37, 47.

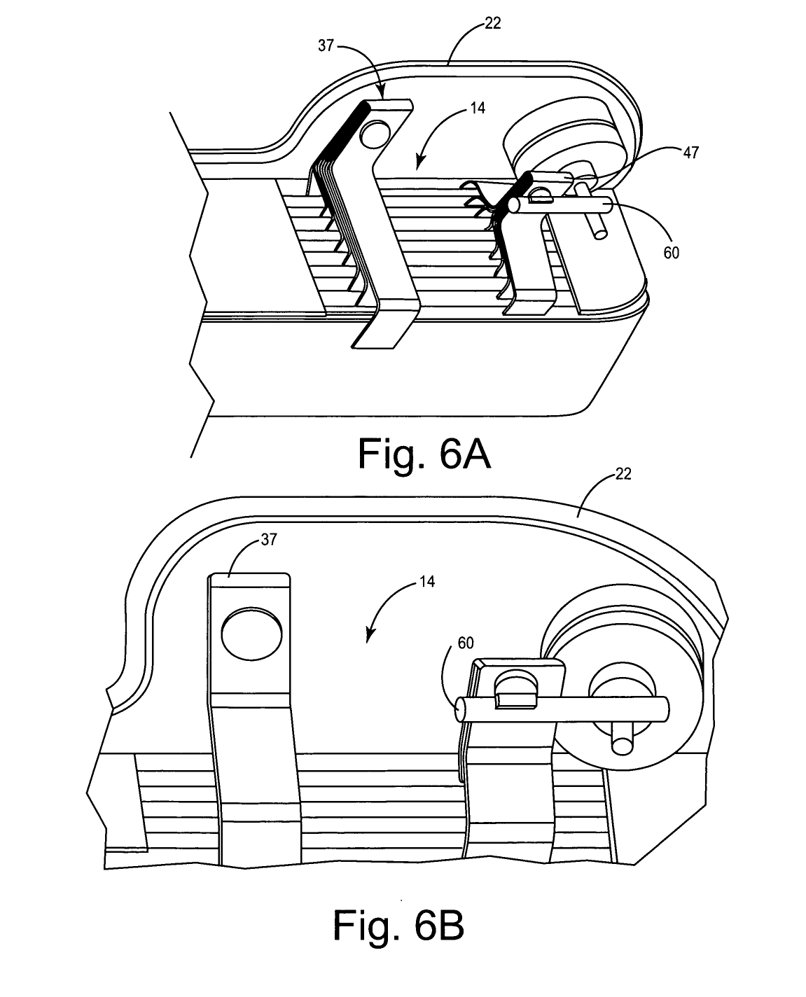

In this embodiment, greater than two tabs are welded together by a single beam at one time. Typically, up to ten tabs are welded through laser penetration. In another embodiment, two or more welds and weld zones 70 (e.g. overlapped or non-overlapped welds 72, 74) are formed in set of tabs 37, as depicted in FIG. 5. FIGS. 5A and 5B depict top and bottom views 76, 78 of weld zone 70. After the laser penetration welding operation, set of tabs 37 are mechanically and electrically joined. A similar laser penetration weld operation is applied to cathode tabs 47. Laser penetration welding of set of tabs 37 and 47 makes it unnecessary to have laser blocking objects around tabs 37 and 47 to prevent the laser from hitting and damaging other materials within the cell. In another embodiment, tabs 37 and/or 47 to first portion 22 (or lid) of housing 12 or to a feed-through pin 60 by a single penetration weld, as shown in FIGS. 6A and 6B, respectively. Specifically, set of tabs 37 are aligned with upper portion 22 of housing 12. A single continuous or multiple-pulse laser beam passes through set of tabs 37 and then through upper portion 22 to create a single laser penetration weld. Similarly, set of tabs 47 are aligned with feed-through pin 60. A single continuous or multiple-pulse laser beam passes through set of tabs 47 and through feed-through pin 60 to create another single laser penetration weld.

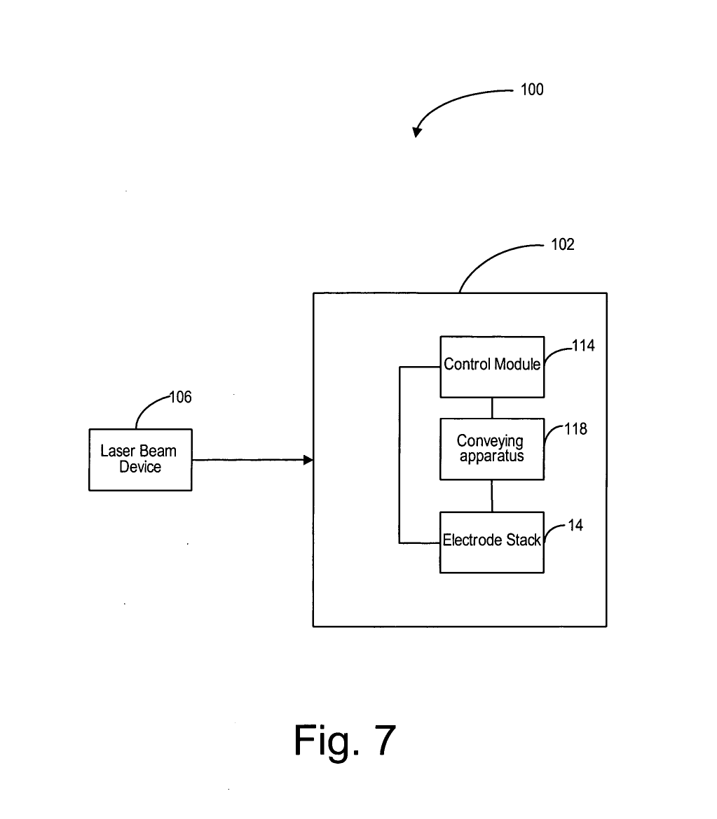

FIG. 7 depicts a system 100 that automatically creates at least one laser penetration weld in a set of tabs 37 and/or 47. System 100 includes a laser penetration beam device 106, a control module 114, and a conveying apparatus 118. Control module 114 is connected via buses to laser beam device 106, and conveying apparatus 118. Control module 114 signals conveying apparatus 118 to reposition electrode stack 14 (or assembly of 14, 12, and 60) so that tabs 37 and/or 47 are orthogonal or slightly slanted to a path of a laser beam from the laser beam device 106. Control module 114 signals laser beam device 106 to strike set of tabs 37 with a beam that performs RSW or ultrasonic welding in order to securely hold set of tabs 37 and/or 47 in position before and during the process of laser penetration. After set of tabs 37 and/or 47 are securely positioned, control module 114 signals laser penetration beam device 106 to emit a laser beam in order to create a laser penetration weld in set of tabs 37 and/or 47.

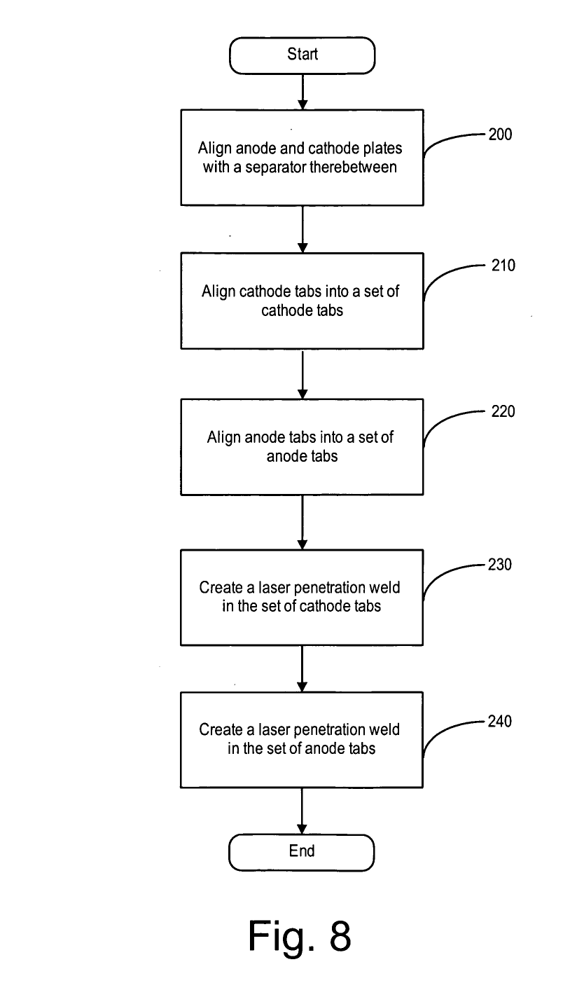

FIG. 8 is a flow diagram for creating a laser penetration weld in a set of tabs. At block 200, a stack of alternating anode and cathode plates are aligned with a separator therebetween is formed. Each cathode plate includes a cathode tab extending therefrom and each anode plate includes an anode tab extending therefrom. At block 210, the cathode tabs are aligned into a set of cathode tabs. At block 220, the anode tabs are aligned into a set of anode tabs. At block 230, the cathode tabs are welded through laser penetration. At block 240, the anode tabs are welded through laser penetration welding.

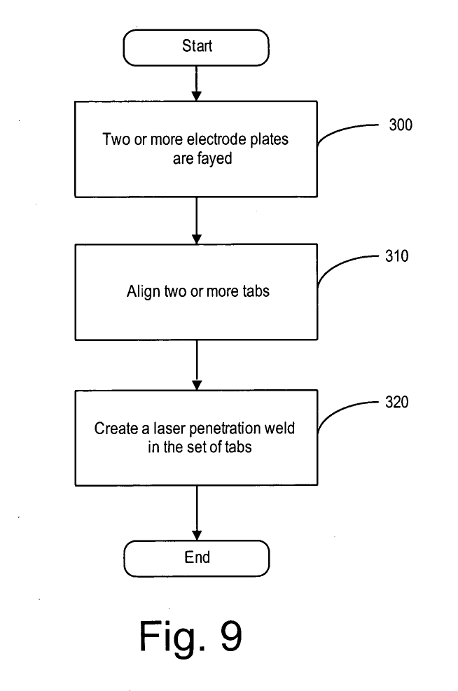

FIG. 9 is another flow diagram for creating a laser penetration weld in a set of tabs. At block 300, two or more electrode plates (e.g. anode or cathode plates) are fayed. Each cathode plate includes a cathode tab extending therefrom and each anode plate includes an anode tab extending therefrom. At block 310, two or more tabs are aligned into a set of cathode tabs or anode tabs. At block 320, the set of tabs are welded through laser penetration welding. The laser energy initiates melting on the top plate of the stack and progressively melts through the plates below until the plate on the bottom of the stack is melted therethrough. A melt mark is visible on the bottom of the stack. A weld zone is formed by conduction mode of welding or by deep-penetration-mode (i.e. keyhole mode) welding.

Numerous applications of the claimed invention may be implemented. For example, two laser penetration welds may be made to couple a set of tabs to a housing. Specifically, a single continuous laser beam may pass through set of tabs 37. Another single continuous laser beam may pass the set of tabs and then through upper portion 22 to create another single laser penetration weld. A similar process may be applied to the feed-through pin 60. Moreover, while a laser penetration weld is described as being created by, for example, a single continuous or multiple pulse laser weld, skilled artisans understand that a single laser penetration weld may be formed by a first pulse laser beam striking the face of a set of tabs 37 and a second pulse laser beam striking a face of a bottom plate of tabs 37.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method comprising:
Aligning the set of the tabs associated with a set of electrode plates;
fixturing a set of tabs through one of resistance spot welding and ultrasonic welding;
aligning the set of tabs associated with the set of electrode plates; and
creating a laser penetration weld through the set of tabs at a single continuous time, wherein the set of tabs being greater than two tabs.

2. The method of claim 1, wherein the laser penetration weld includes one of a feed-through pin and an upper portion of a housing.

3. The method of claim 1, wherein the electrode plate is one of an anode plate and a cathode plate.

4. The method of claim 1, wherein a weld zone for the laser penetration weld extends from a top surface to a bottom surface of the set of tabs.

5. The method of claim 1, wherein a single laser penetration weld connects at least three tabs.

6. The method of claim 1, wherein a single laser penetration weld connects at least 10 tabs.

7. A method of forming an electrode stack of an electrochemical cell in an implantable medical device comprising:
fixturing a set of tabs through one of resistance spot welding and ultrasonic welding;
forming a stack of alternating anode and cathode plates with a separator therebetween, each of the cathode plates including a cathode tab extending from an edge thereof, each of the anode plates including an anode tab extending from an edge thereof;
aligning the cathode tabs into a stack of cathode tabs;
aligning the anode tabs into a stack of anode tabs;
laser penetration welding the cathode tabs in the stack of cathode tabs together; and
laser penetration welding the anode tabs in the stack of anode tabs together.

8. The method of claim 7, wherein the laser penetration welding creates a first weld zone extending from a first end to a second end of the anode tabs.

9. The method of claim 7, wherein the laser penetration welding creates a second weld zone extending from a first end to a second end of the cathode tabs.

10. The method of claim 7, further comprising:
holding the aligned stack of cathode tabs together before laser welding.

11. The method of claim 7, wherein the aligned stack of cathode tabs being together with a tool.

12. An apparatus for automatically producing at least one laser penetration weld in a set of tabs comprising:
storage media including instructions stored thereon which when executed cause a computer system to perform a method including:
fixturing a set of tabs through one of resistance spot welding and ultrasonic welding;
aligning a set of tabs associated with a set of electrode plates; and
creating a laser penetration weld through the set of tabs at a single continuous time, wherein the set of tabs being greater than two tabs.

13. The apparatus of claim 12, wherein the laser penetration weld includes one of a feed-through pin and an upper portion of a housing.

14. The apparatus of claim 12, wherein the electrode plate is one of an anode plate and a cathode plate.

15. The apparatus of claim 12, wherein a weld zone for the laser penetration weld extends from a top surface to a bottom surface of the set of tabs.

16. The apparatus of claim 12, wherein a single laser penetration weld connects at least three tabs.

17. The apparatus of claim 12, wherein a single laser penetration weld connects at least 10 tabs.

18. A method comprising:
fixturing a set of tabs through one of resistance spot welding and ultrasonic welding;
aligning the set of tabs associated with a set of electrode plates;
striking a face of a top tab with a first laser beam;
striking a face of a bottom tab with a second laser beam; and
creating a laser penetration weld through the set of tabs at a single continuous time, wherein the set of tabs being greater than two tabs.

19. The method of claim 18, wherein the second and first beam strike the set of tabs at about a same time.

20. The method of claim 18, wherein the second and first beam strike the set of tabs at a different time.
